(19) United States
(12) Patent Application Publication
(10) Pub. No.: US 2006/0250794 A1
(43) Pub. Date: Nov. 9, 2006

(54) High intensity light arrangement and method

(76) Inventor: Lawrence I. Wechsler, Great Neck, NY (US)

Correspondence Address: Lawrence I. Wechsler, One Wooleys Lane, Great Neck, NY, 11023, US

(21) Appl. No.: 11/372,366

(22) Filed: Mar. 9, 2006

Related U.S. Application Data
(60) Provisional application No. 60/660,106, filed on Mar. 9, 2005.

(51) Int. Cl. F21V 21/00; F21V 19/00

(52) U.S. Cl. 362/249; 362/382

(57) ABSTRACT

A light a light arrangement employs at least one support extending in a length direction along an arrangement axis, to which individual light bulbs are mountably receivable in ordered fashion. The lights are of the type having an orientation axis, along which a base and a light emitting portion are disposed in respective axial positions. When installed to the support, the lights are energizable from a power source to emit light in a desired direction, for example, downward, when in a use orientation. To achieve the desired characteristics, at least a portion of the lights are laterally arranged on one side of the arrangement axis and a remaining portion arranged on the opposite side of the arrangement axis, the lights being positioned such that the orientation axes of the light elements run crosswise to the arrangement axis of the support to which they are received.

### CROSS REFERENCE TO RELATED APPLICATIONS

This application claims the benefit of U.S. Provisional Application No. 60/660,106 filed Mar. 9, 2005 entitled HIGH INTENSITY LIGHT ARRANGEMENT AND METHOD.

### BACKGROUND OF THE INVENTION

The present invention relates to a light arrangement, and more particularly to a light arrangement suited for use in lighting an area, including one of elongated linear dimension, such as, for example, for disposition over a plant bench in the home or a conservatory, and which can provide light of greater intensity than many conventional fixtures, and a method of providing such lighting.

Many types of light fixtures are available for providing artificial light in connection with a number of diverse activities. These conventionally use various types of light sources, including incandescent, fluorescent, metal halide and sodium lamps. Each of these light sources have particular advantage and disadvantage, and selection of a particular type is dependent in large part on the desired application. For example, incandescent bulbs can be dimmed, but are the least light efficient, generating greater heat and less light per watt consumed than the remaining type lamps. Metal halide and sodium lamps require a ballast to operate. Magnetic ballasts, which can generate noise, are generally required, at present, for larger output bulbs. Fluorescent bulbs, while having greater efficiency than incandescent bulbs, cannot be dimmed.

Often, the level of light and spectral range emitted is the factor of greatest importance to a user. Particularly in the respective fields of aquaria and horticulture, wherein photosynthetic processes are involved, selection of a type of light is predicated upon production of sufficient levels of light intensity within a usable spectrum. While fluorescent lights, which are readily available and relatively inexpensive to buy and operate, and which output light in a spectral range usable in photosynthesis, they have heretofore not generally not been utilized in a manner which can provide a sufficient level of light required by many plants and simulated reef environments. For this reason, metal halide lighting, while much more expensive that fluorescent lighting, is generally the lighting of choice for many applications requiring high intensity light.

Compact fluorescent bulbs are available, which are intended for replacement of less efficient incandescent bulbs, and which employ an integral ballast and, optionally, a standard screw base. These bulbs can, according to present design, emit up to about four times the amount of light than a standard incandescent bulb using the same power, and therefore, because of their greater light efficiency, run much cooler while outputting comparable levels of light of other types of lighting sources. However, a light fixture and/or light arrangement, employing these and/or other type light elements (conventional and those yet to be developed), emitting similar or more intense light, has heretofore not delivered a suitable intensity of light for many applications, particularly for use in growing plants, such as cactus and succulents, which have high light requirements in the range of 20,000 lux and above.

It would therefore be desirable to provide a light arrangement that utilizes the high levels of light output of individual compact fluorescent or other type of light elements in a manner which effectively distributes the light provided thereby over a region of illumination, including one of elongated dimension.

Accordingly, it is an object of the invention to provide a light arrangement which overcomes the drawbacks of the prior art.

It is a further object of the invention to provide a light arrangement which provides relatively uniform and high degree of light intensity, even over a longitudinal extent of an elongated illumination region.

It is an additional object to provide a light arrangement in a form that is economical and functionally versatile.

### SUMMARY OF THE INVENTION

In accordance with these and other objects of the invention, there is provided a light arrangement in which individual light bulbs are arranged in a manner in which the bulbs are spatially and orientationally distributed over a length direction in particular ordered fashion to effect emission of light advantageously of relatively uniform and effective intensity over a substantial entirely of a length range of the arrangement. The light elements are of the type themselves having a light orientation axis, along which a base (or electrical input portion) and a light emitting portion are disposed in respective axial positions.

Briefly stated, a light arrangement employs at least one support extending in a length direction along an arrangement axis, to which individual light bulbs (elements) are mountably receivable in ordered fashion. An arrangement plane, which essentially bisects the support along the arrangement axis, defines the relative positioning of the lights in accordance with the invention. When installed to the support, the lights are energizable from a power source to emit light in a desired direction, for example, downward, when in a use orientation. To achieve the desired characteristics, at least a portion of the lights are laterally arranged on one side of the arrangement axis and another portion arranged on the opposite side of the arrangement axis, the lights being positioned such that the orientation axes of the light elements run crosswise to the arrangement axis (and arrangement plane) of the support to which they are received. Advantageously, the bases and light emitting portions of the lights on one side of the arrangement axis face in divergent directions to the lights on the opposite side thereof.

According to an embodiment of the invention, a light support is provided conveniently in the form of a rigid housing having a length (in a direction of the arrangement axis) and width dimension, and which is optionally provided with a reflective underside advantageously serving as a light reflector for concentrating light downward (or another direction in which it is directed). A series of electrically powered light sockets are installed to the housing in lateral positions thereof (i.e., laterally to either side of the arrangement axis, across the width dimension), such that both lateral sides of the housing carry a portion of the sockets which are dispersed along a lengthwise extent thereof. While the invention is readily suited to a light arrangement of elongated dimension, in theory, a light arrangement in accordance with the invention is also contemplated to embrace a light arrangement of square dimension (length and width of equal length) or, having a width greater than the length.

While the above described light arrangement can be wired in any suitable manner, such as by use of pick-tail parallel wiring, a preferred embodiment utilizes a pair of buses which interconnect the plural sockets which power the light elements over both respective legs thereof. The precise manner of connection of socket to bus is not essential to the inventive embodiment, and can be achieved, for example, by a specially configured socket which has two through-holes through which insulated bus wires are passed, and which further includes a mechanism for piercing the insulation and making an electrical connection between socket and bus. Another example would be to provide a series of taps along a length of each of the individual buses to which leads from the individual sockets are connectable.

While virtually any light source can be used in the above described arrangements, use of compact fluorescent light elements is considered particularly advantageous, at present, since each light can be selected to emit a desired spectrum and intensity of light for a given application. Additionally, since each light has its own ballast, the fixture using such lights is, itself, advantageously light weight, maintenance-free, and lights of different wattage can be freely substituted without requiring a change in ballast, as would be otherwise required in a fixture utilizing standard fluorescent bulbs. However, it is contemplated that other light sources may be developed in the future, and the invention is intended to apply to the use of these new lights elements.

The above, and other objects, features and advantages of the present invention will become apparent from the following description read in conjunction with the accompanying drawings.

### BRIEF DESCRIPTION OF THE DRAWINGS

FIG. 1 is a side elevational view of a conventional compact fluorescent light;

FIG. 2 is an end view of a light fixture providing a light arrangement in accordance with an embodiment of the invention;

FIG. 3 is a bottom plan view of the embodiment of FIG. 2;

FIG. 4 is a bottom plan view of another embodiment of the invention directed to a light arrangement of elongated dimension;

FIG. 5 is a bottom plan view of another embodiment of the invention;

FIG. 6 is a bottom plan view of a further embodiment of the invention; and

FIG. 7 is a schematic representation depicting a manner of electrical connection of light sockets in an arrangement in accordance with an embodiment of the invention.

### DETAILED DESCRIPTION OF THE PREFERRED EMBODIMENT

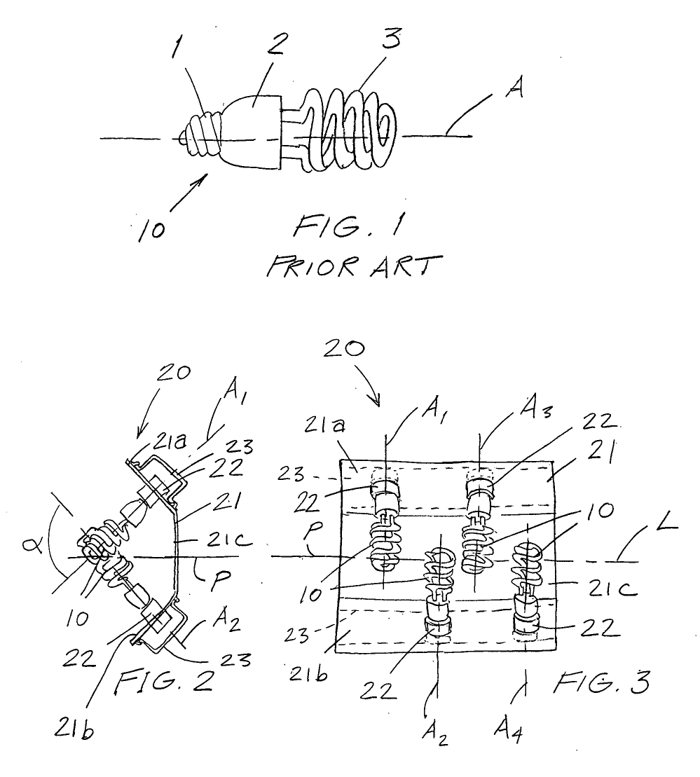

Referring now to the figures, and in particular FIG. 1, a conventional compact fluorescent light element is shown at 10. Light element 10 includes a screw base 1, a ballast housing 2 and a spiral light emitting portion 3 (which is also sometimes of a shape other than spiral, and which is not depicted, yet also equally suitable for use in connection with the disclosed invention), all arranged sequentially in a direction of an orientation axis A and disposed in respective axial positions therealong.

Turning to FIGS. 2 and 3, an embodiment of a light arrangement is shown, generally designated 20. Light arrangement 20 is provided as a combination of elements including a housing 21, light sockets 22 and light elements 10 received therein. Housing 21 is conveniently constructed of a rigid material, for example, bent sheet steel, of similar construction, for example, as standard shop fixture reflectors. Housing 21 is advantageously bent to form a generally trapezoidal shape in cross-section (see FIG. 2), including angled lateral portions 21a, 21b and a central portion 21c extending therebetween. Light sockets 22, which are arranged on opposite sides of an arrangement plane P (FIG. 2) which shares a locus coincident with an arrangement axis L, are fixed to the housing 21, in a suitable manner. For example, as depicted in the present embodiment, the light sockets 22 are ring type sockets (i.e., comprised of two threaded halves), and a plurality of mounting holes are formed in the lateral portions 21a, 21b of housing 21. Sockets 22 are assembled to the housing 21 by captive insertion thereof through these mounting holes. Since the light sockets 22 are mounted to the angled lateral portions 21a, 21b, light elements 10 on each of opposed ones of lateral portions 21a, 21b are arranged along respective orientation axes A₁, A₂ describing an included angle α relative to one another. While so angled, their orientation axes are still are considered to be crosswise to the arrangement axis and plane, as defined herein. Such angled orientation is, however, not critical to the inventive concept.

While the precise manner of electrical wiring of light sockets 22 is not depicted, covers 23 can optionally be provided which extend along the length direction of the housing 21 (codirectional with an arrangement axis L), shielding the backs of the sockets 22 and any wiring interconnecting them, the covers 23 being held conveniently to the housing by formed flanges or the like.

With regard to wiring, the above described light arrangement can be wired in any suitable manner, such as by use of pick tail parallel wiring. However, a preferred embodiment utilizes a pair of buses, i.e., one bus for each parallel leg which interconnects the plural sockets which, in turn, power the light elements. The precise manner of connection of socket to bus is not essential to the inventive embodiment, and can be achieved, for example, by a specially configured socket which has two through-holes through which insulated bus wires are passed, and which further includes a mechanism for piercing the insulation and making an electrical connection between socket and bus. An embodiment of this type is shown schematically in FIG. 7, in which eight light sockets 22′ of the aforementioned configuration are linked in parallel. Another example would be to provide a series of taps (or connector ports) along a length of each of the individual buses to which leads from the individual sockets are connectable at various points along a run thereof.

Turning to FIG. 4, an embodiment incorporating the concepts of the invention is directed to a light arrangement of elongated dimension. Light arrangement 20′ includes a housing 21′, which like the previous embodiment of FIGS. 2 and 3, is advantageously bent to form a generally trapezoidal shape in cross-section (identical to FIG. 2, by analogy), including angled lateral portions 21a′, 21b′ and a central portion 21c′ extending therebetween. All other aspects of the embodiment that apply to the previous embodiment are applicable to the present embodiment, and therefore a description of same will not be repeated. The embodiment of FIG. 4 is illustrative of the fact that the light placements can be repeated over any desired length simply by adding additional light elements anywhere along an axil position of arrangement axis L′ (arrangement plane P′).

It has been noted herein that the invention arranges individual light elements having a base and a light emitting portion which are positioned along an orientation axis, such that a portion of the light elements are laterally positioned on one side of a light arrangement axis of a support, and a remaining portion arranged on the opposite side of a light arrangement axis, the lights being positioned such that the orientation axes of the light elements run crosswise to the arrangement axis of the support. In the above described embodiments, the light elements are arranged with their respective orientation axes generally perpendicular to the arrangement axis. However, the term “crosswise,” as used herein with respect to the arrangement axis, is defined broadly as including a positioning in which a straight locus in parallel or coincident alignment with the orientation axis would intersect the light arrangement axis L. Stated another way, “crosswise” to the arrangement axis defines any positioning in which a linear extension of the orientation axis would intersect the arrangement plane P.

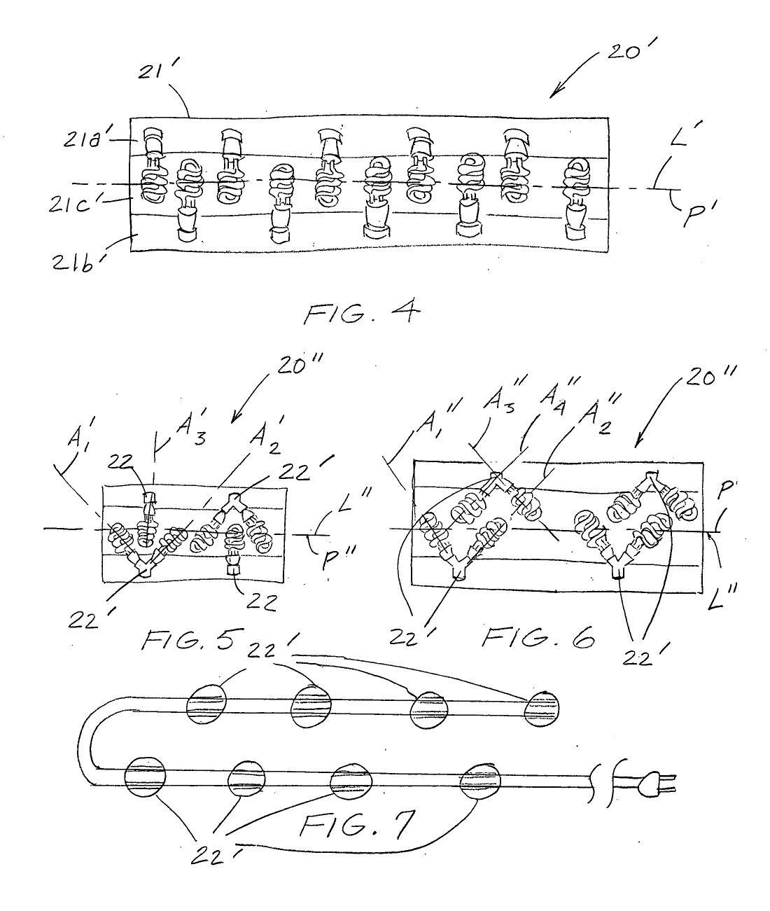

Referring to FIGS. 5 and 6, two examples of alternative light arrangements are depicted in which the orientation axes of at least a portion of the light elements are positioned crosswise to a respective arrangement axis L″, L′″ (arrangement planes P″, P′″), yet at angles other than right angles thereto.

As shown in FIGS. 5 and 6, two light arrangements 20″ and 20′″ are depicted in which special sockets 22′ having a Y configuration presenting a pair of angularly divergent socket base receptacles are used either in combination with the standard socket 22 (FIG. 5), or exclusively (FIG. 6). In FIG. 5, the special socket 22′ directs the light elements along respective angles axes A₁′ and A₂′ and the standard socket along a perpendicular axis A₃′ (relative to arrangement axis L″). Similarly, in FIG. 6, the light elements received in special sockets 22′ are arranged along axes A₁″, A₂″ A₃″ and A₄″ which are crosswise (although not perpendicular) to arrangement axis L′″ (arrangement plane P′″).

It is noted that any given light arrangement need not incorporate a repeating pattern of the above examples, but can rather use any combination of these and other suitable patterns governed by the disclosed broad parameters.

Furthermore, other types of compact fluorescent light elements can be used, including those without integrated ballasts, in which case a ballast could be provided, for example, as a mounted part to the fixture support or separate therefrom for wired connection thereto.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

What is claimed is:

1. A light arrangement, comprising:
a support for receiving lights in powered engagement having an arrangement axis, the lights having a base and a light emitting portion oriented along an orientation axis, at least a portion of the lights being laterally arrangable on one side of the arrangement axis and a remaining portion arranged on the opposite side of the arrangement axis the lights when received to the support, the lights being positioned such that the orientation axes of the lights run crosswise to the arrangement axis of the support to which they are received.

2. A light arrangement according to claim 1, wherein when the lights are received to the support, the orientation axes of lights describe an included angle α relative to one another, wherein α is less than 180°.

3. A light arrangement according to claim 1, wherein the orientation axes are approximately perpendicular to the arrangement axis when the lights are received to the support.

4. A light arrangement according to claim 1, further comprising sockets mounted on said support for providing said powered engagement.

5. A light arrangement according to claim 4, wherein at least a portion of said sockets each include socket base receptacles for receiving at least two lights.

6. A light arrangement according to claim 1, further comprising a ballast, the lights being of a type which does not include a ballast as a part thereof.

7. A light arrangement according to claim 1, wherein the bases and light emitting portions of the lights on one side of the arrangement axis face in divergent directions to the lights on the opposite side thereof.

8. A method of providing light, comprising:
providing light elements each including an electrical input portion and a light emitting portion arranged axially along a light orientation axis;
arranging a first portion of the light elements on one side of a light arrangement axis;
arranging a second portion of the light elements on another side of the light arrangement axis; and
positioning at least a portion of the light elements such the light orientation axis of each of said at least a portion of the light elements runs crosswise to said light arrangement axis.

9. A light fixture, comprising:
a support having an arrangement axis; and
light sockets for powerable reception of lights such that when received to the light sockets, at least a portion of the light sockets being laterally arranged on one side of the arrangement axis and a remaining portion arranged on the opposite side of the arrangement axis, the lights when received to the light sockets being positioned such that the orientation axes of the lights run crosswise to the arrangement axis.
